(19) United States
(12) Patent Application Publication
(10) Pub. No.: US 2005/0129199 A1
(43) Pub. Date: Jun. 16, 2005

(54) Input device, mobile telephone, and mobile information device

(76) Inventor: Naoya Abe, Osaka (JP)

Correspondence Address: DARBY & DARBY P.C., P. O. BOX 5257, NEW YORK, NY, 10150-5257, US

(21) Appl. No.: 10/504,171

(22) PCT Filed: Feb. 6, 2003
(86) PCT No.: PCT/JP03/01279

(30) Foreign Application Priority Data
Feb. 7, 2002 (JP) 2002-031516

(51) Int. Cl. H04M 11/00

(52) U.S. Cl. 379/90.01

(57) ABSTRACT

An input device having touched position detecting means for outputting a signal indicating a touched position during a period of time of touch when the touched position detecting means is touched, wherein a character and a symbol are inputted to be displayed on a display screen. Provided are: a virtual keyboard in which each virtual key corresponding to a plurality of characters or symbols is arranged corresponding to each divided area on the touched position detecting means; means for outputting, during the period of time of touch, a code signal indicating a character or a symbol of a virtual key corresponding to an area including the touched position; means for temporarily displaying on the display screen a character or a symbol of the outputted code signal; and means for determinately displaying the character or the symbol on the display screen when the code signal has disappeared.

### TECHNICAL FIELD

The present invention relates to: an input device which comprises touched position detecting means, such as a touch pad or a touch panel, for outputting a signal indicating a touched position during a period when it is touched (or another period related to said period), wherein a character and a symbol (or a group of characters and a group of symbols) are inputted to be displayed on a display screen; a mobile telephone comprising the input device; and a mobile information device comprising the input device.

### BACKGROUND TECHNIQUE

An input device in a mobile telephone which has been conventionally used is generally provided with a ten-key keypad since the input device cannot include many keys. Accordingly, the input of a kana character, an alphabet character or the like into such an input device needs a plurality of times of key operations per one character.

Consequently, there is a problem that the key operation is complex, confusing and troublesome, and the ten-key keypad, which has many movable parts, breaks down easily.

As a technique related to such a problem, for example, disclosed in Japanese Patent Application Laid-Open No. 2001-282427 is a “Mobile Terminal” which displays a Japanese kana syllabary table so that a desired character can be selected from the table by moving a finger touching the touched position detecting means in order to change a character which is presently selected.

Moreover, disclosed in Japanese Patent Application Laid-Open No. H10-254624 (1998) is a “Keyboard Touch Pad”, wherein a touch pad is employed as information inputting means and arranged in a position different from a screen display unit.

### DISCLOSURE OF INVENTION

The present invention has been made in view of the aforementioned situation, and it is an object thereof to provide an input device in which keys can be arranged on space-saving touched position detecting means in an extremely high density, with which any one of kana characters, alphabet characters and the like can be selected and inputted by a simple operation, and which is irrefrangible.

Another object of the present invention is to provide a mobile telephone in which keys can be arranged on space-saving touched position detecting means in an extremely high density, with which any one of kana characters, alphabet characters and the like can be selected and inputted by a simple operation, and the input device of which is irrefrangible.

Another object of the present invention is to provide a mobile information device in which keys can be arranged on space-saving touched position detecting means in an extremely high density, with which any one of kana characters, alphabet characters and the like can be selected and inputted by a simple operation, and the input device of which is irrefrangible.

An input device according to the first invention which has touched position detecting means for outputting a signal indicating a touched position thereof during a period of time of touch, and is configured so as to input a character and a symbol to be displayed on a display screen, characterized by comprising: a virtual keyboard in which each virtual key corresponding to a plurality of characters or symbols is arranged corresponding to each divided area on the touched position detecting means; means for outputting, during the period of time of touch, a code signal indicating a character or a symbol of a virtual key corresponding to an area including the touched position; means for temporarily displaying on the display screen a character or a symbol of the code signal outputted by the means; and means for determinately displaying the character or the symbol on the display screen when the code signal has disappeared.

An input device according to the second invention which has touched position detecting means for outputting a signal indicating a touched position thereof during a period of time of touch, and is configured so as to input a group of characters and a group of symbols to be displayed on a display screen, characterized by comprising: a virtual keyboard in which each virtual key corresponding to a plurality of groups of characters or groups of symbols is arranged corresponding to each divided area on the touched position detecting means; means for outputting, during the period of time of touch, a code signal indicating a group of characters or a group of symbols of a virtual key corresponding to an area including the touched position; means for temporarily displaying on the display screen a group of characters or a group of symbols of the code signal outputted by the means; and means for determinately displaying the group of characters or the group of symbols on the display screen when the code signal has disappeared.

An input device according to the third invention is characterized by further comprising means for expanding an area including the touched position during the period of time of touch.

An input device according to the fourth invention is characterized in that the means for determinately displaying provides a determinate display when the code signal has continued, in a first time period immediately before the code signal has disappeared, for more than a second time period which is shorter than the first time period.

An input device according to the fifth invention is characterized by further comprising means for displaying on the display screen a portion centering on an area including the touched position of the virtual keyboard or a whole area of the virtual keyboard.

An input device according to the sixth invention is characterized in that the virtual keyboard includes one or a plurality of virtual keys respectively indicating a predetermined function and the input device further comprises: means for outputting a signal indicating the function when an area of the virtual key includes the touched position; and means for executing the function of the signal outputted by the means.

An input device according to the seventh invention is characterized by further comprising a plurality of kinds of virtual keyboards and means for switching the virtual keyboards, wherein a virtual keyboard switched by the means is displayed on the display screen.

An input device according to the eighth invention is characterized in that a virtual keyboard is a ten-key keypad, a number or a symbol corresponding to each the area is illustrated on the touched position detecting means, and display of the ten-key keypad on the display screen is prohibited when the virtual keyboard is switched to the ten-key keypad.

An input device according to the ninth invention is characterized in that projections for each the area are provided on the touched position detecting means.

An input device according to the tenth invention is characterized in that a groove is provided on a boundary of each the area on the touched position detecting means.

An input device according to the eleventh invention is characterized in that characters and symbols are divided into a plurality of sets based on a predetermined condition and each virtual key respectively corresponds to a character or a symbol respectively indicating a set, wherein when a character or a symbol indicating a set is selected, each virtual key corresponds to a character or a symbol of the set indicated by the selected character or symbol.

An input device according to the twelfth invention is characterized by further comprising: means for selectively displaying, instead of a virtual keyboard, a virtual key or information related to content displayed on the display screen; and means for switching between a state where the means operates and a state where the means does not operate.

An input device according to the thirteenth invention is characterized by further comprising means for outputting voice corresponding to the content displayed on the display screen.

A mobile telephone according to the fourteenth invention is characterized by comprising the input device according to any one of first through thirteenth inventions, wherein a character, a group of characters, a symbol or a group of symbols inputted through the input device is displayed on the display screen and a function inputted and instructed through the input device is executed.

A mobile information device according to the fifteenth invention is characterized by comprising the input device according to any one of first through thirteenth inventions, wherein a character, a group of characters, a symbol or a group of symbols inputted through the input device is displayed on the display screen and a function inputted and instructed through the input device is executed.

The first invention has touched position detecting means for outputting a signal indicating a touched position during a period of time of touch, and is configured so as to input a character and a symbol to be displayed on a display screen. Each virtual key on the virtual keyboard corresponding to a plurality of characters or symbols is arranged corresponding to each divided area on the touched position detecting means, and outputting means outputs, during a period of time of touch, a code signal indicating a character or a symbol of a virtual key corresponding to an area including a touched position. Temporarily displaying means temporarily displays a character or a symbol of the outputted code signal on the display screen, and determinately displaying means determinately displays the character or the symbol on the display screen when the code signal has disappeared.

With this structure, keys can be arranged on space-saving touched position detecting means in an extremely high density, generating of an input mistake can be decreased since an character is determined after checking an inputted character, any one of kana characters, alphabet characters and the like can be selected and inputted by a single operation, and an irrefrangible input device can be realized.

The second invention comprises touched position detecting means for outputting a signal indicating a touched position during a period of time of touch when the touched position detecting means is touched, wherein a group of characters and a group of symbols are inputted to be displayed on a display screen. Each virtual key on the virtual keyboard corresponding to a plurality of groups of characters or groups of symbols is arranged corresponding to each divided area on the touched position detecting means and outputting means outputs, during a period of time of touch, a code signal indicating a group of characters or a group of symbols of a virtual key corresponding to an area including a touched position. Temporarily displaying means temporarily displays a group of characters or a group of symbols of the outputted code signal on the display screen, and determinately displaying means determinately displays the group of characters or the group of symbols on the display screen when the code signal has disappeared.

With this structure, keys can be arranged on space-saving touched position detecting means in an extremely high density, generating of an input mistake can be decreased since a group of characters or a group of symbols is determined after checking a group of inputted characters or symbols, any one of groups of kana characters, groups of alphabet characters and the like can be selected and inputted by a single operation, and an irrefrangible input device can be realized.

With the third invention, in which expanding means expands an area including the touched position during a period of time of touch, generating of an input mistake can be decreased even in a space-saving device, keys can be arranged on space-saving touched position detecting means in an extremely high density, any one of kana characters, alphabet characters and the like can be selected and inputted by a single operation, and an irrefrangible input device can be realized.

With the fourth invention, in which determinately displaying means provides a determinate display when the code signal has continued, in a first time period immediately before the code signal has disappeared, for more than a second time period which is shorter than the first time period, generating of an input mistake can be decreased by preventing chattering at the time of input, keys can be arranged on space-saving touched position detecting means in an extremely high density, any one of kana characters, alphabet characters and the like can be selected and inputted by a single operation, and an irrefrangible input device can be realized.

With the fifth invention, in which displaying means displays on the display screen a portion centering on an area including the touched position of the virtual keyboard or a whole area of the virtual keyboard, an input is easy even for a beginner, keys can be arranged on space-saving touched position detecting means in an extremely high density, any one of kana characters, alphabet characters and the like can be selected and inputted by a single operation, and an irrefrangible input device can be realized.

In the sixth invention, the virtual keyboard includes one or a plurality of virtual keys having a predetermined function, and when an area of the virtual key includes the touched position, outputting means outputs a signal indicating the function and executing means executes the function of the outputted signal.

With this structure, a function key is provided, keys can be arranged on space-saving touched position detecting means in an extremely high density, any one of kana characters, alphabet characters and the like can be selected and inputted by a single operation, and an irrefrangible input device can be realized.

With the seventh invention, in which a plurality of kinds of virtual keyboards are provided and a virtual keyboard switched by switching means is displayed on the display screen, the user can select a virtual keyboard with which an input is easy for him, keys can be arranged on space-saving touched position detecting means in an extremely high density, any one of kana characters, alphabet characters and the like can be selected and inputted by a single operation, and an irrefrangible input device can be realized.

With the eighth invention, in which a virtual keyboard is a ten-key keypad, a number or a symbol corresponding to each area is illustrated on the touched position detecting means, and display of the ten-key keypad on the display screen is prohibited when the virtual keyboard is switched to the ten-key keypad, it is easy to dial, keys can be arranged on space-saving touched position detecting means in an extremely high density, any one of kana characters, alphabet characters and the like can be selected and inputted by a single operation, and an irrefrangible input device can be realized.

With the ninth invention, in which projections for each area are provided on the touched position detecting means, an input is easy, generating of an input mistake can be decreased, keys can be arranged on space-saving touched position detecting means in an extremely high density, any one of kana characters, alphabet characters and the like can be selected and inputted by a single operation, and an irrefrangible input device can be realized.

With the tenth invention, in which a groove is provided on a boundary of each area on the touched position detecting means, an input is easy, generating of an input mistake can be decreased, keys can be arranged on space-saving touched position detecting means in an extremely high density, any one of kana characters, alphabet characters and the like can be selected and inputted by a single operation, and an irrefrangible input device can be realized.

In the eleventh invention, characters and symbols are divided into a plurality of sets based on a predetermined condition and each virtual key corresponds to a character or a symbol indicating a divided set. When a character or a symbol indicating a divided set is selected, each virtual key corresponds to a character or a symbol of the set indicated by the selected character or symbol.

With this structure, an input is easy, generating of an input mistake can be decreased, keys can be arranged on space-saving touched position detecting means in an extremely high density, any one of kana characters, alphabet characters and the like can be selected and inputted faster by two operations, and an irrefrangible input device can be realized.

In the twelfth invention, displaying means selectively displays, instead of the virtual keyboard, a virtual key or information related to content displayed on the display screen, and switching means switches between a state where the displaying means operates and a state where the displaying means does not operate.

With this structure, an input is easy, generating of an input mistake can be decreased, keys can be arranged on space-saving touched position detecting means in an extremely high density, keys to be arranged can be reduced, any one of kana characters, alphabet characters and the like can be selected and inputted by a simple operation, and an irrefrangible input device can be realized.

With the thirteenth invention, in which voice outputting means outputs voice corresponding to content displayed on the display screen, an input is easy even for a visually impaired person, generating of an input mistake can be decreased, keys can be arranged on space-saving touched position detecting means in an extremely high density, any one of kana characters, alphabet characters and the like can be selected and inputted by a simple operation, and an irrefrangible input device can be realized.

With the fourteenth invention, which comprises an input device according to any one of first through thirteenth inventions, wherein a character, a group of characters, a symbol or a group of symbols inputted through the input device is displayed on the display screen and a function inputted and instructed through the input device is executed, generating of an input mistake can be decreased, keys can be arranged on space-saving touched position detecting means in an extremely high density, any one of kana characters, alphabet characters and the like can be selected and inputted by a simple operation, and a mobile telephone with an irrefrangible input device can be realized.

With the fifteenth invention, which comprises an input device according to any one of first through thirteenth inventions, wherein a character, a group of characters, a symbol or a group of symbols inputted through the input device is displayed on the display screen and a function inputted and instructed through the input device is executed, generating of an input mistake can be decreased, keys can be arranged on space-saving touched position detecting means in an extremely high density, any one of kana characters, alphabet characters and the like can be selected and inputted by a simple operation, and a mobile information device with an irrefrangible input device can be realized.

### BRIEF DESCRIPTION OF THE DRAWINGS

FIG. 1 is a front view showing the appearance of an embodiment of an input device and a mobile telephone according to the present invention;

FIG. 2 is a block diagram showing an example of the structure of the input device and the mobile telephone shown in FIG. 1;

FIG. 3 is an explanatory view showing an example of the structure of a touch pad;

FIG. 4 is an explanatory view showing an example of a virtual keyboard;

FIG. 5 is an explanatory view showing an example of a virtual keyboard;

FIG. 6 is an explanatory view showing an example of the display on a display panel;

FIG. 7 is an explanatory view showing an example of the display on the display panel;

FIG. 8 is an explanatory view showing an example of the display on the display panel;

FIG. 9 is an explanatory view showing an example of the display on the display panel;

FIG. 10 is an explanatory view showing an example of the display on the display panel;

FIG. 11 is a flow chart showing an example of the operations of the input device and the mobile telephone according to the present invention;

FIG. 12 is a flow chart showing an example of the operations of the input device and the mobile telephone according to the present invention;

FIG. 13 is a flow chart showing an example of the operations of the input device and the mobile telephone according to the present invention;

FIG. 14 is an explanatory view showing an example of the operations of the input device and the mobile telephone according to the present invention;

FIG. 15 is an explanatory view showing an example of the operations of the input device and the mobile telephone according to the present invention;

FIG. 16 is a flow chart showing an example of the operations of the input device and the mobile telephone according to the present invention;

FIG. 17 is an explanatory view showing an example of the operations of a key buffer;

FIG. 18 is a flow chart showing an example of the operations of the input device and the mobile telephone according to the present invention;

FIG. 19 is a flow chart showing an example of the operations of the input device and the mobile telephone according to the present invention;

FIG. 20 is a flow chart showing an example of the operations of the input device and the mobile telephone according to the present invention;

FIG. 21 is a flow chart showing an example of the operations of the input device and the mobile telephone according to the present invention;

FIG. 22 is a front view showing the appearance of an embodiment of a mobile information device according to the present invention; and

FIG. 23 is an explanatory view showing an example of the appearance of the input device according to the present invention.

### THE BEST MODE FOR CARRYING OUT THE INVENTION

The following description will explain the present invention with reference to the drawings illustrating some embodiments thereof.

### Embodiment 1

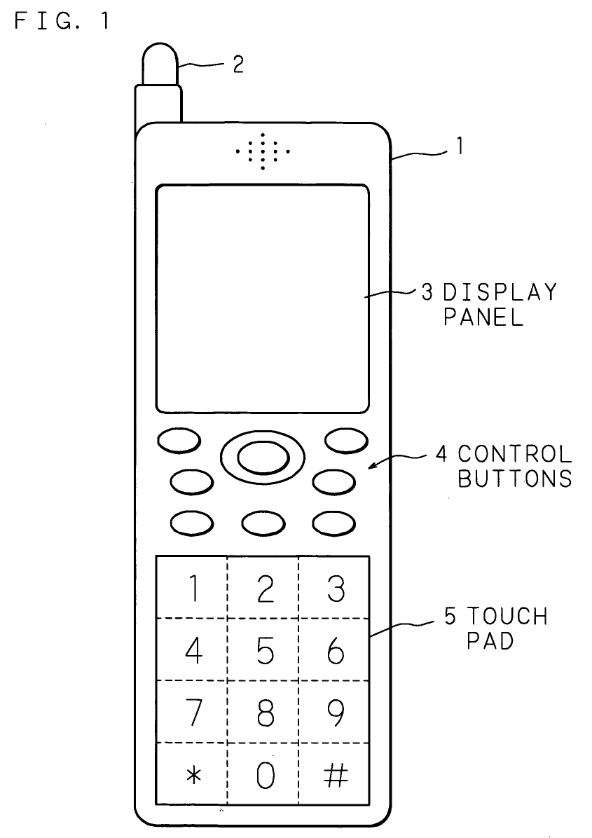

FIG. 1 is a front view showing the appearance of Embodiment 1 of an input device and a mobile telephone according to the present invention. The mobile telephone 1 has a transmit-receive antenna 2 on the upper side of a case, and a display panel 3 which is a display screen configured as a liquid crystal panel is provided at the front upper part of the case. Provided below the display panel 3 are control buttons 4, and a touch pad 5, which is touched position detecting means of the input device according to the present invention, is provided below the control buttons 4.

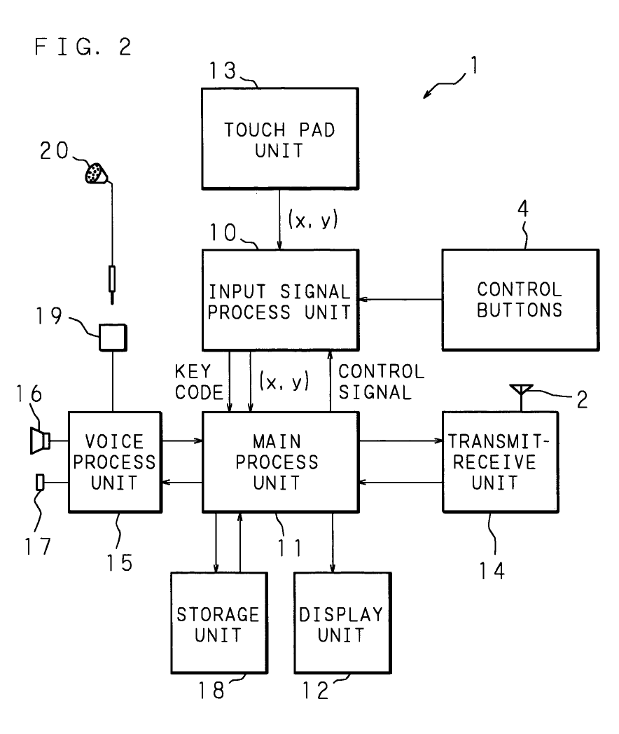

FIG. 2 is a block diagram showing an example of the structure of the input device and the mobile telephone shown in FIG. 1. Regarding the mobile telephone 1, the input device is composed of a touch pad unit 13 and an input signal process unit 10 and the touch pad unit 13 includes the aforementioned touch pad 5. When the user touches the touch pad 5, the touch pad unit 13 outputs a signal indicating the coordinates (x, y) of the touched position during the period when the touch pad 5 is touched (or another period related to said period).

The input signal process unit 10 repeatedly samples signal outputted from the touch pad unit 13, and when a signal exists, the input signal process unit 10 takes in the coordinate (x, y) values of the signal.

The input signal process unit 10 analyzes the coordinate (x,
y) values taken in, retrieves a key code corresponding to an area including the coordinate (x, y) values and gives the key code to a main process unit 11. The input signal process unit 10 also processes an input signal from the control buttons 4 and gives the process result to the main process unit 11.

The main process unit 11 performs processes of the mobile telephone 1 other than the input. For displaying a virtual keyboard on a display unit 12 having the display panel 3, the main process unit 11 also holds the arrangement data of the virtual keyboard and displays the virtual keyboard on the display panel 3 of the display unit 12 according to the key code given by the input signal process unit 10.

For continuously rewriting the virtual keyboard so that the position on the touch pad 5 touched by the user comes to the center of the displayed virtual keyboard, the input signal process unit 10 gives the coordinate (x, y) values as well as the key code to the main process unit 11.

The main process unit 11 reads voice data corresponding to displayed content including the virtual keyboard of the display panel 3 out of a storage unit 18 and gives the voice data to a voice process unit 15. It should be noted that the voice data may be stored in a memory incorporated in the main process unit 11.

The voice process unit 15 converts the given voice data into a voice signal and outputs the voice signal through an earphone jack 19. A visually impaired user can perform input operations while listening to voice corresponding to content displayed on the display panel 3 through an earphone 20.

The main process unit 11 gives data to be transmitted to a transmit-receive unit 14 provided with the antenna 2 and the transmit-receive unit 14 transmits the given data.

The data received by the transmit-receive unit 14 is given to the main process unit 11 and the main process unit 11 displays the data on the display panel 3 of the display unit 12 or gives the data to the voice process unit 15 according to the kind of the data. The voice process unit 15 converts the given data into a voice signal and outputs the voice signal through a speaker 16.

The voice process unit 15 converts the voice signal inputted through a microphone 17 into data and gives the data to the main process unit 11. The main process unit 11 transmits the given data through the transmit-receive unit 14.

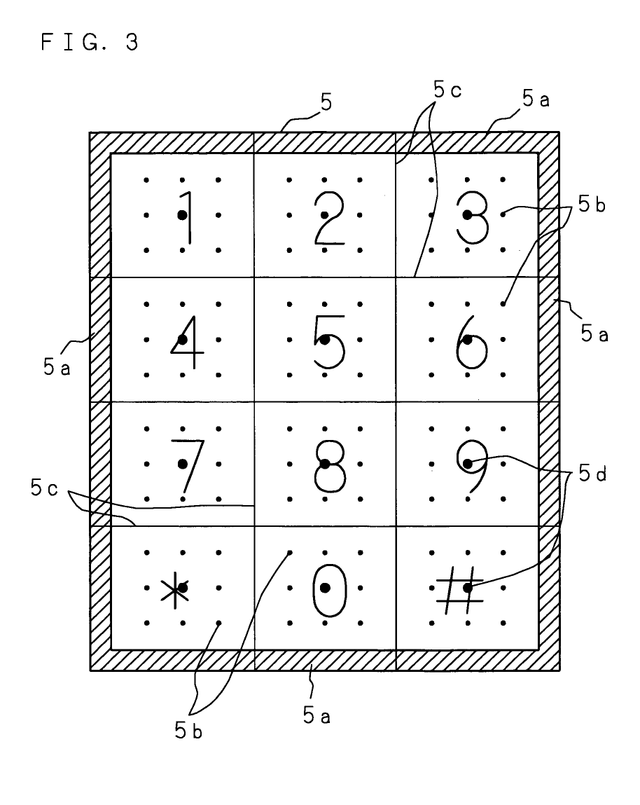

FIG. 3 is an explanatory view showing an example of the structure of the touch pad 5. The touch pad 5 may be of any kind as long as the touch pad 5 continuously outputs absolute coordinate values and can be operated by a finger.

Though special processing on the touch pad surface is basically unnecessary, a visual clue can be given in the stage before the user starts key operations if the key arrangement of a typical virtual keyboard is printed. FIG. 3 shows an example in which a ten-key keypad for a telephone is printed. It should be noted that, in an actual operation, input while looking at the print on the touch pad surface actually lowers the operational efficiency specially when a virtual keyboard provided with many keys is used.

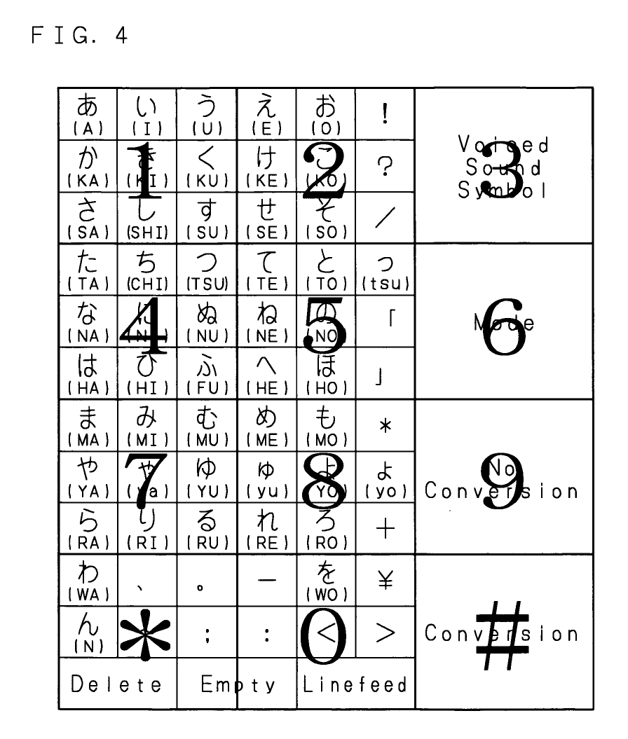

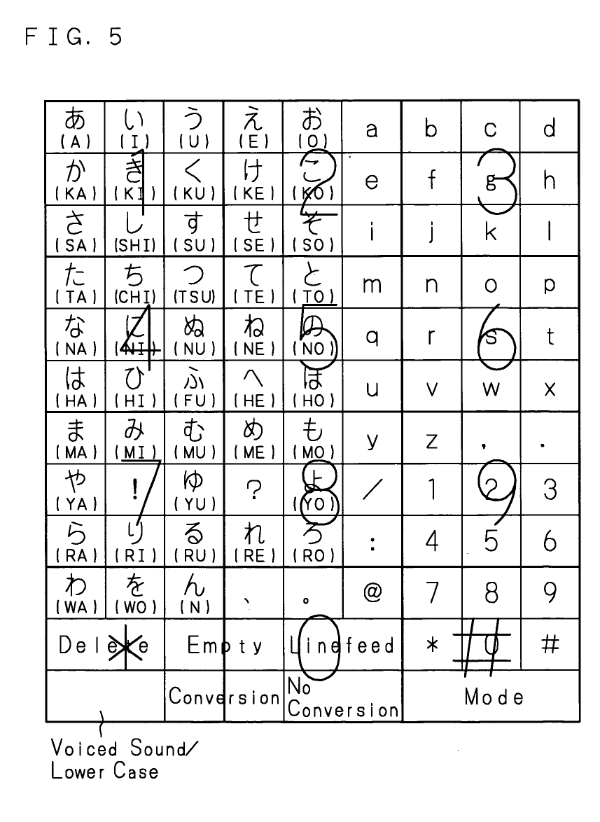

A clue for key operations can be given by adding a structure such as a projection and a groove on the touch pad surface. In FIG. 3, small projections 5b (projections) are arranged at the center part of an area corresponding to each key, corresponding to the key arrangement of the virtual keyboard of FIG. 4 and FIG. 5 which will hereinafter be described. Moreover, a groove 5c is provided at a boundary part of an area corresponding to each key of the ten-key keypad for a telephone, and furthermore, a small projection 5d (projection) at the center of a section divided by grooves 5c is made slightly larger.

When a virtual keyboard is disposed on the touch pad surface, a space 5a is provided around the virtual keyboard. As will hereinafter be described, though an area of each virtual key is changed for preventing chattering, the area of a virtual key can be prevented from getting out of the touch pad surface since the space 5a is provided.

The touch pad 5 is operated by touching the same with a single finger such as the thumb or the index finger, or a plurality of fingers such as the index finger, the middle finger and the ring finger. Alternatively, a pen can be used instead of a finger when the touch pad is a pen input compliant one on the surface of which any processing such as a projection is not provided. Moreover, by switching the mode, the touch pad 5 can be used as a pointing device, or a device for recognizing a free line input or a hand written character.

FIG. 4 is an explanatory view showing an example of a virtual keyboard to be disposed on the touch pad 5. It is possible to allocate a plurality of virtual keyboards for the touch pad 5 and use a virtual keyboard by switching the virtual keyboards. FIG. 4 shows a ten-key virtual keyboard for a telephone and a kana input virtual keyboard in an overlapped way. It should be noted that, in practice, only a ten-key keypad for a telephone is printed on the touch pad 5 and a kana input virtual keyboard is not printed.

The “Voiced Sound Symbol”, for example, of the kana input virtual keyboard has a function of conversion into the voiced sound symbol, the semi voiced sound symbol, the lower case character and the like. The “Mode” has a function of switching from a Japanese syllabary character mode to an alphanumeric mode. The “No Conversion” has a function of determining a Japanese syllabary character without converting the same into a Kanji character. The “Conversion” has a function of converting a Japanese syllabary character into a Kanji character.

By operating the mode key on the virtual keyboard to change the mode, the virtual keyboard can be switched to a kana-alphanumeric virtual keyboard with which kanas, alphabets, numerals and symbols can be inputted as shown in FIG. 5, for example.

Furthermore, many kinds of virtual keyboards, such as a symbol virtual keyboard including other symbols, also can be allocated.

Moreover, an item selecting virtual keyboard including a group of characters or a group of symbols also can be allocated. It is also possible to relate a word or a face mark to each virtual key, for example.

Many keys can be arranged in a small space on the touch pad 5. In the example shown in FIG. 5, characters, alphabets, numerals and symbols are disposed within a range, which is to be occupied by a ten-key keypad of a normal telephone.

The key arrangement of each virtual keyboard is independent from others and layout can be created freely. Though FIG. 4 shows an example in which nine kana keys respectively correspond to respective keys of the ten-key keypad for a telephone, it is not necessary to match the key boundary.

The key arrangement of the virtual keyboard is preferably the one with which the user is familiar and can be easily inspired, such as the same key arrangement as a normal telephone as a ten-key virtual keyboard for a telephone, the key arrangement in the order of the Japanese syllabary as a kana input virtual keyboard, the key arrangement in the alphabetical order or the key arrangement of a JIS keyboard as the alphanumeric virtual keyboard, or the like.

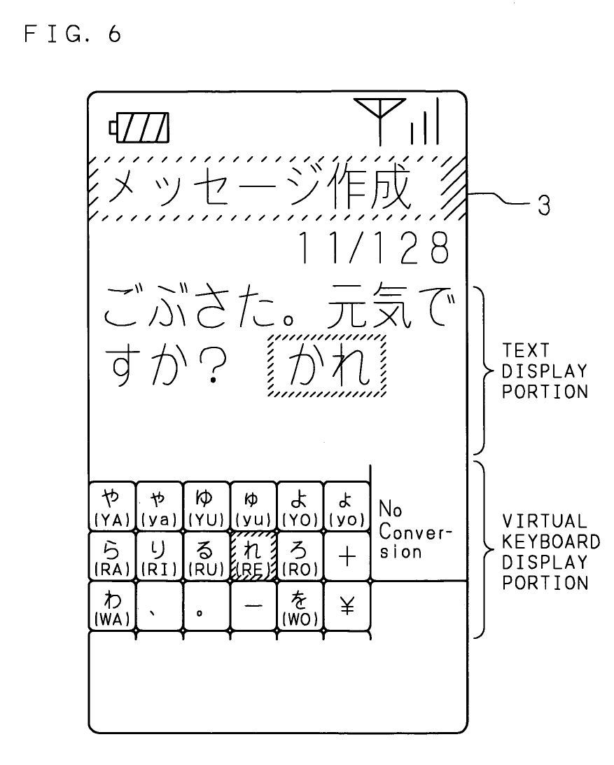

FIG. 6 is an explanatory view showing an example of the display on the display panel 3. The display on the display panel 3 may be the same as that of a conventional telephone, or a virtual keyboard can be displayed as an input assist. When the display panel 3 is small in size, only the key, which is presently selected, and the vicinity centering on the key are displayed. In the example of FIG. 6, the “Re” key is presently selected.

When the user touches the touch pad 5, a key (“Re” in FIG. 6) corresponding to the touched point on the touch pad 5 is selected on the virtual keyboard presently selected and a virtual keyboard centering on the key is displayed on a virtual keyboard display portion at the lower part of the display panel 3.

When this key is a character key, the character is temporarily inputted and temporarily displayed on a text display portion at the upper part of the display panel 3.

Then, when the user moves his finger while touching the touch pad 5 with the finger and the touched point comes into an adjoining key area, the character temporarily inputted is discarded and a new character is temporarily inputted.

A character corresponding to a key area which the finger has been touching immediately before (or a key area touched before) the finger comes off the touch pad 5 is determinately inputted (determinately displayed).

In a case where the selected key is a control key, a special key or the like, the aforementioned operation is basically the same and the function of the key is not executed in the temporal input (temporal display) state. Here, a mark indicating the function of the key may be displayed on the text display portion., or in a case of a special key such as a voiced sound symbol, the function may be executed.

It should be noted that, though the aforementioned case is the one where a character is inputted by a single operation, a character can be inputted by two operations (touch inputs). In a case of kana character input, for example, though the number of operation times increases in input by two operations (two touch inputs), the input can be expected to be more efficient since the time required for key selection for one operation is reduced.

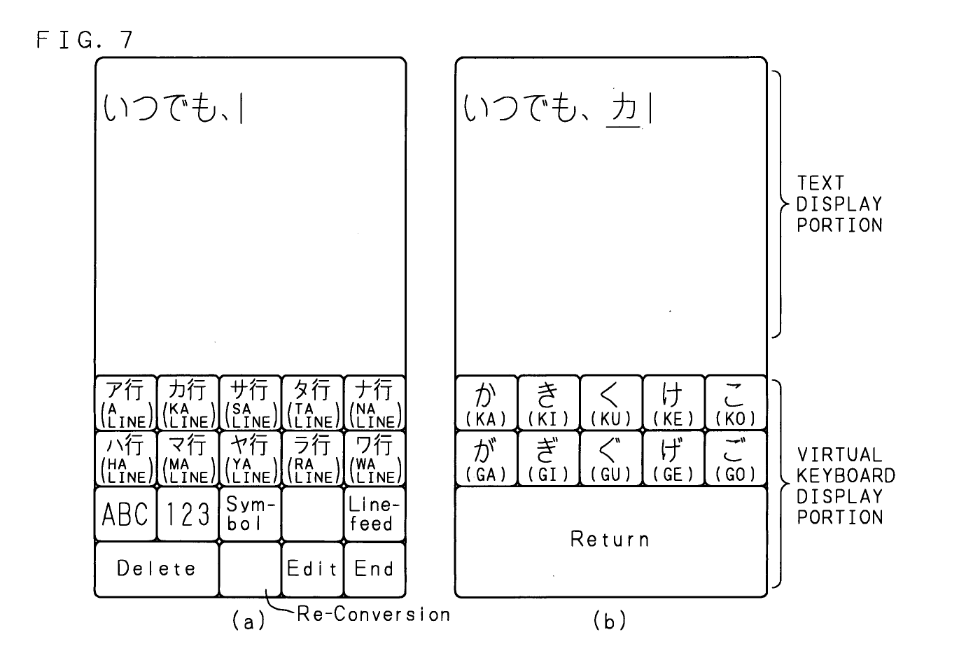

For inputting a kana character, keys which respectively correspond to a set of characters (such as a line of characters or characters of the same kind) such as the “A” line through “Wa” line, “ABC” (for inputting alphabets) and “123” (for inputting numbers) are first displayed on the virtual keyboard display portion at the lower part of the display panel 3 as shown in FIG. 7(a).

When any key is selected from the “A” line through “Wa” line by the first operation, the arrangement of the virtual keys on the virtual keyboard display portion and the touch pad surface is switched, and characters belonging to the selected line including characters with the voiced consonant or the semivoiced consonant are displayed as shown in FIG. 7(b).

Here, displayed at the cursor position of the text display unit is “Ka” when the “Ka” line has been selected, for example, or “Sa” when the “Sa” line has been selected, so as to show the selected line with katakana or the like. It should be noted that symbols frequently used such as punctuation and a dash are included in “Wa” line with “Wa”, “Wo” and “N”.

When a target character is selected from those selected characters by the second operation, the selected character is displayed at the cursor position.

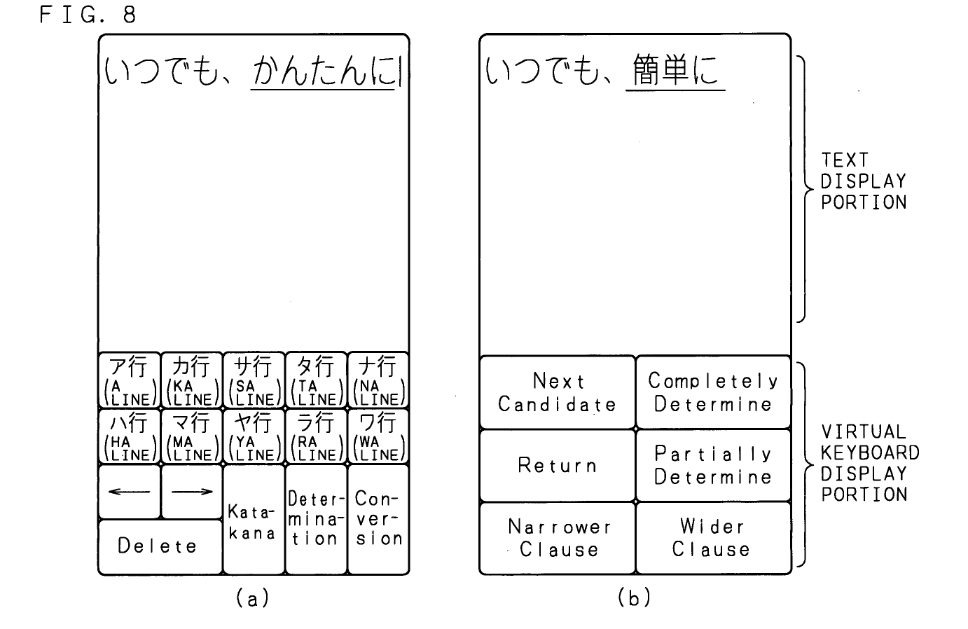

After the second operation is executed, the virtual keyboard for selecting a line from “A Line” through “Wa Line” is displayed again. Here, the kind of the displayed keys other than the “A Line” through “Wa Line” is different between a case where there is an undetermined character which has not been converted into a kanji yet and a case where there is no undetermined character. That is, when there is no undetermined character, keys such as “ABC”, “123”, “Symbols”, “Linefeed”, “Blank”, “Edit” and “Re-conversion” are displayed as shown in FIG. 7(a). When there is an undetermined character, keys such as “Conversion”, “Determination”, “Katakana”, “←” and “→” are displayed as shown in FIG. 8(a). It should be noted that the “Delete” key is displayed in the both cases.

When the “Conversion” key is selected in the state shown in FIG. 8(a), the undetermined character is converted into a character candidate and keys necessary for the next operation such as “Next Candidate”, “Return”, “Narrower Clause”, “Completely Determine”, “Partially Determine” and “Wider Clause” are displayed as shown in FIG. 8(b).

Since unnecessary keys are not displayed according to the content displayed on the displayed panel 3 as described above, the number of keys to be displayed can be decreased, each key can be displayed in a larger size, and the options showed to the user can be decreased.

When the display panel 3 is small in size as in a mobile telephone, the virtual keyboard to be displayed occupies a considerably large portion of the display panel 3. If the user is familiar with the key arrangement of the input device according to the present invention, such a problem can be solved by displaying only information on a key temporarily selected instead of the whole virtual keyboard (minimum display mode). Furthermore, by notifying an explanation on the key temporarily selected with voice, the device can be used as an input device for a visually impaired person (voice mode).

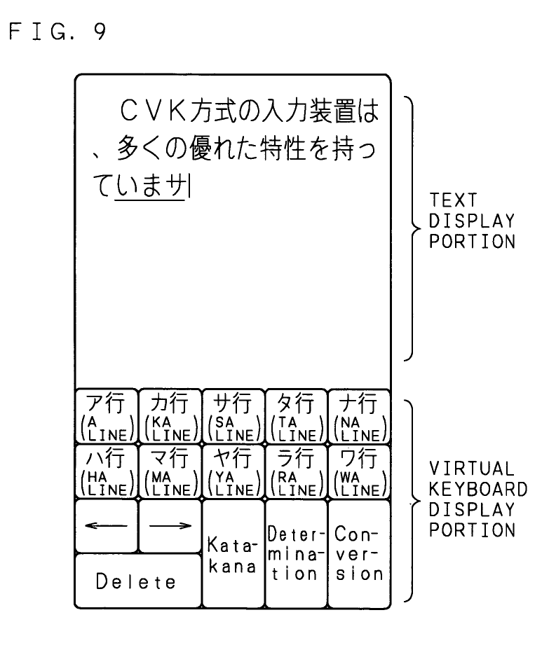

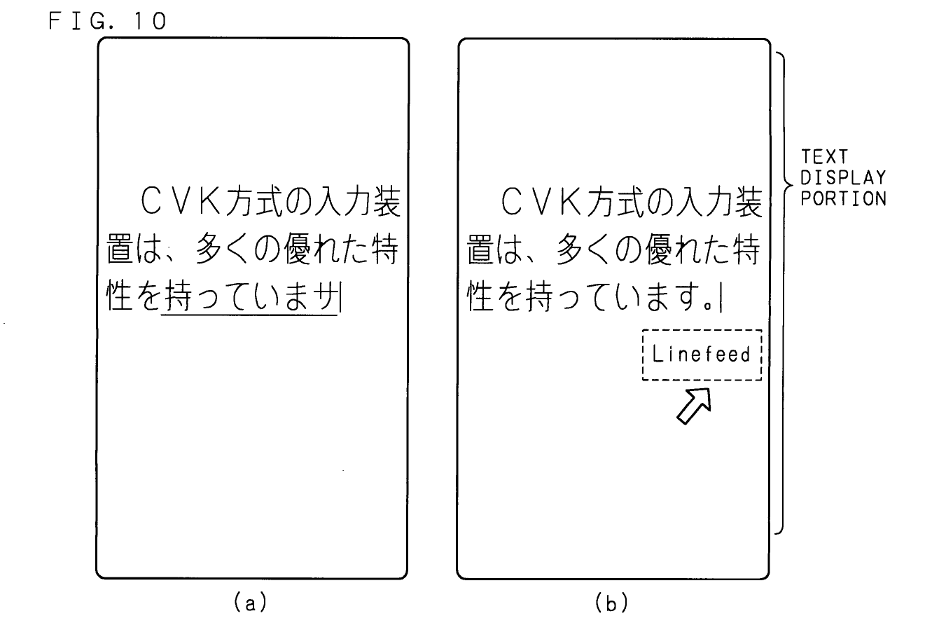

In the minimum display mode, the arrangement of the operation keys on the touch pad surface is not different from that of a normal mode except the fact that the whole virtual keyboard is not displayed on the display panel 3. When the user is touching a key such as a kana key (which includes “A Line” through “Wa Line” in the case of two touch inputs), an alphabet key, a numeral key or a symbol key, those characters are displayed at the cursor positions also in the normal mode (illustrated in FIG. 9) and a new display is unnecessary as shown in FIG. 10(a). When the user touches any of other keys such as “Conversion” or “Delete”, an explanation on keys such as “Conversion”, “Delete” and “Linefeed” is displayed in the vicinity of the cursor as shown in FIG. 10(b) in order to notify the user of the kind of the key temporarily selected.

In the voice mode, when any key is temporarily selected, an explanation on the key is outputted with voice. For example, outputted is voice “A Line” when the “A Line” key has been temporarily selected, voice “Delete” when the “Delete” key has been temporarily selected, or voice “Blank” when the “Blank” key has been temporarily selected. Voice explaining the virtual keyboard is also outputted according to need when the virtual keyboard is switched. For example, when the virtual keyboard is switched to a kana input virtual keyboard, voice “Kana Input” is outputted.

Moreover, in a state where the “Sa Line” key is being touched (not determined yet), for example, “Sa” is displayed at the cursor position as shown in FIG. 10(a) and voice “Sa Line” is outputted. In a state where “Linefeed” is temporarily selected, an explanation on the key such as “Linefeed” is displayed in the vicinity of the cursor as shown in FIG. 10(b) and voice “Linefeed” is outputted.

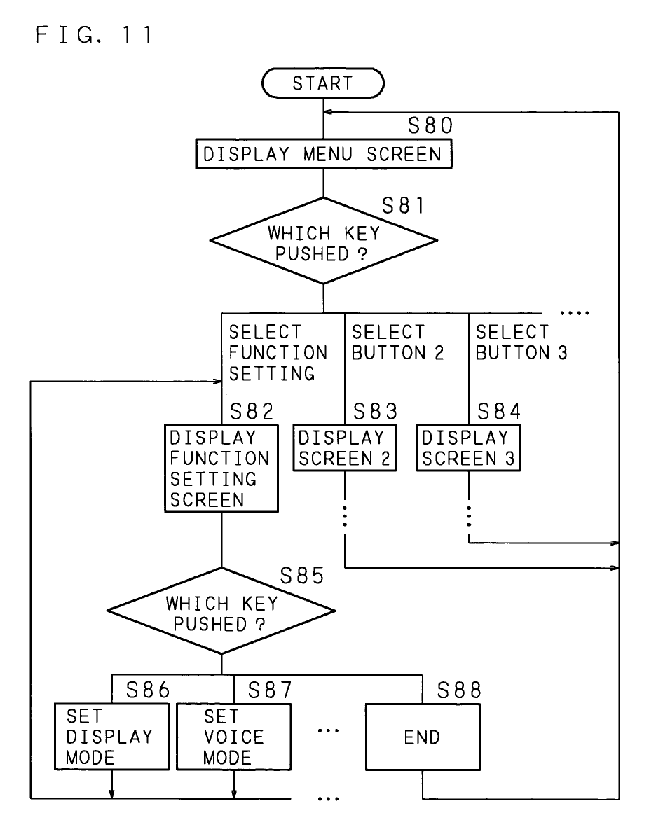

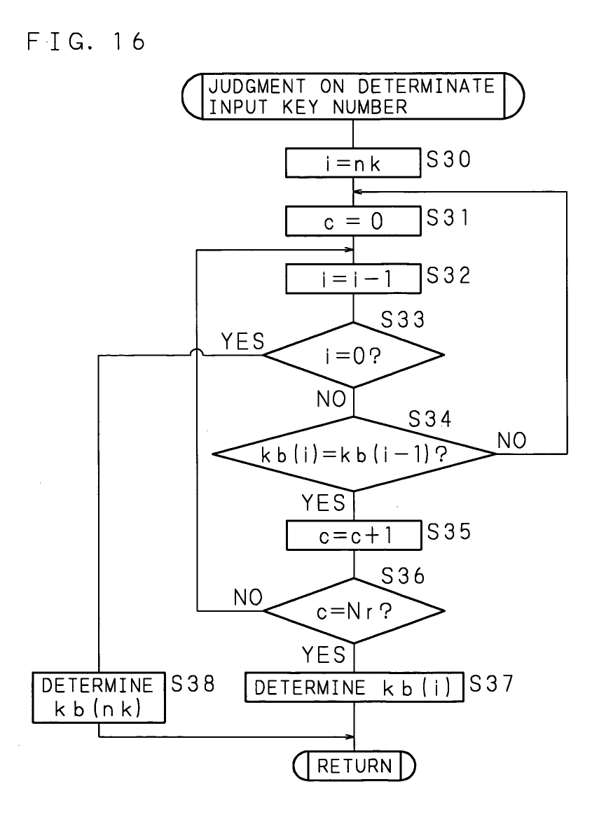

The following description will explain the input operations of the mobile telephone 1 and the input device constructed as described above, with reference to the flow charts of FIG. 11 to FIG. 13, FIG. 16 and FIG. 18 to FIG. 21 illustrating the same.

The main process unit 11 displays (a virtual keyboard corresponding to) a menu screen on the display panel 3 of the display unit 12 (FIG. 11: S80), after a program starts, or depending on the situation. In a mobile telephone, for example, items such as “Transmit-receive of Mail”, “Web Function”, “Telephone Directory” and “Function Setting” are displayed as keys.

The main process unit 11 then makes the input signal process unit 10 judge which key has been selected and pushed (S81).

When the function setting key has been selected and pushed (S81), the main process unit 11 displays a function setting screen on the display panel 3 of the display unit 12 (S82) and then makes the input signal process unit 10 judge which key has been selected and pushed (S85).

When a setting key of the display mode has been selected and pushed (S85), the main process unit 11 sets the display mode (S86). When a setting key of the voice mode has been selected and pushed (S85), the main process unit 11 sets the voice mode (S87). The main process unit 11 further continues to display the function setting screen on the display panel 3 of the display unit 12 (S82) and makes the input signal process unit 10 judge which key has been selected and pushed (S85), and when an end key is selected and pushed, the main process unit 11 ends the function setting (S88) and returns to display of the menu screen (S80).

The function setting screen includes, among various settings, setting of a display mode and setting of a voice mode. In setting of a display mode, whether a virtual keyboard is displayed (normal mode) on the display panel 3 or not (minimum display mode) is selected. In setting of a voice mode, whether notification with voice is performed or not is selected.

When a button 2 is selected and pushed (S81), the main process unit 11 displays a screen 2 on the display panel 3 of the display unit 12 (S83). When a button 3 is selected and pushed (S81), the main process unit 11 displays a screen 3 on the display panel 3 of the display unit 12 (S84). When processes using those screens end, the main process unit 11 returns to display of the menu screen (S80).

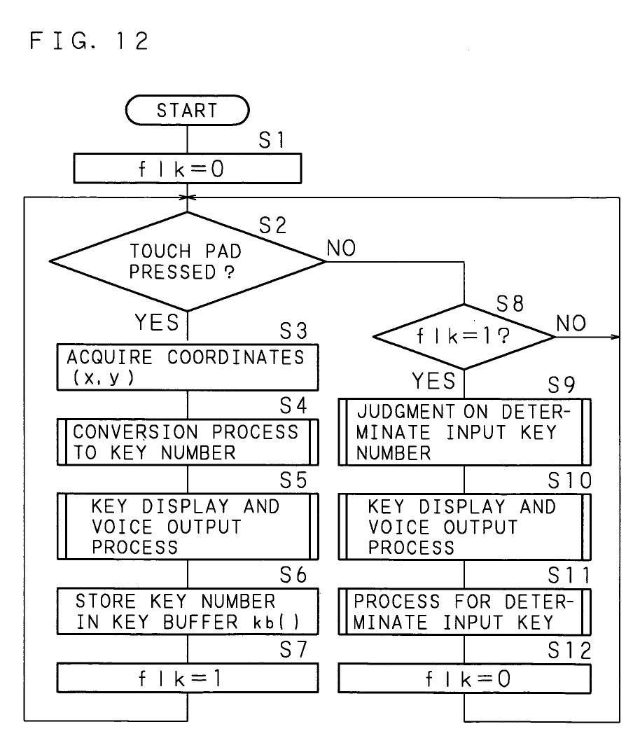

For judging which key has been selected and pushed, the input signal process unit 10 first resets a parameter flk to 0 (FIG. 12: S1). The parameter flk is set to 1 when the touch pad was touched in the previous process cycle (sampling cycle), or set to 0 when the touch pad has not been touched.

The input signal process unit 10 then judges whether the touch pad 5 is pushed (touched) or not (S2), and when the touch pad 5 is pushed, the input signal process unit 10 acquires the coordinates (x, y) of the pushed position from the touch pad 5 (S3).

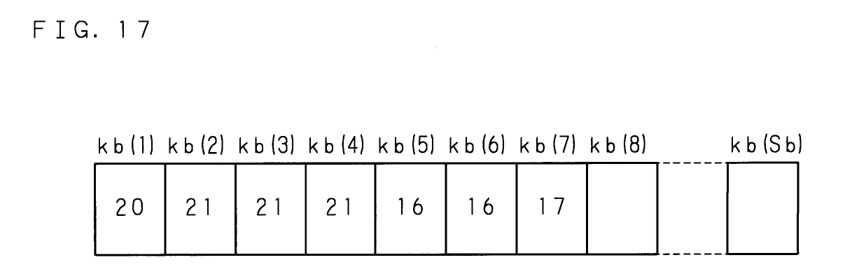

Acquiring the coordinate (x, y) (S3), the input signal process unit 10 converts the coordinates into a key number corresponding to an area including the position thereof (S4). The main process unit 11 receives the converted key number, displays a key and outputs voice (S5). The input signal process unit 10 makes a key buffer kb( ), which is shown in FIG. 17 and will be described later, store the key number (S6) converted at S4.

The main process unit 11 receives the coordinates (x, y) and displays a virtual keyboard centering on the received coordinates on the display panel 3. Whenever the received coordinates (x, y) are changed, the main process unit 11 moves the virtual keyboard.

The input signal process unit 10 then sets the parameter flk to 1 (S7) and judges whether the touch pad 5 is pushed (touched) or not (S2).

When the touch pad 5 is not pushed (S2), the input signal process unit 10 judges whether the parameter flk is 1 or not (S8), and when the parameter flk is 1, the input signal process unit 10 judges a determinate input key number (S9).

The main process unit 11 receives the judged (S9) determinate input key number, displays a key and outputs voice (S10), and then processes the key determinately inputted (S11). Meanwhile, the input signal process unit 10 sets the parameter flk to 0 (S12) and judges whether the touch pad 5 is pushed (touched) or not (S2).

When the parameter flk is not 1 (S8), the input signal process unit 10 judges whether the touch pad 5 is pushed or not (S2).

In the process of conversion into the key number (S4), the input signal process unit 10 judges whether the coordinates (x, y) of the pushed (touched) position of the touch pad 5 is included in the key area or not, with respect to keys on the virtual keyboard the number of which keys is Nk. At the time when it is judged that the coordinates are within a key area, the key number corresponding to the key is determined and the process ends.

Here, the input device and the mobile telephone according to the present invention uses a virtual keyboard by switching a plurality of virtual keyboards depending on the situation. The menu screen and the function setting screen are also realized as virtual keyboards. The attribute of each virtual keyboard is controlled using a virtual keyboard table existing on a memory incorporated in the main process unit 11.

The virtual keyboard table is composed of the following items:
kbn; keyboard number (value for discriminating a virtual keyboard uniquely),
Nk; the number of keys existing on the virtual keyboard, and
Mkb; content of the voice message which is outputted when the voice notification function is switched on and the screen thereof is displayed (for example, regarding the menu screen, voice “Menu Screen” is outputted when the menu screen is displayed).

Besides, a plurality of items related to the shape of the virtual keyboard to be displayed on the screen may be included. For example, the size (width and height) of the virtual keyboard, the position on the display panel 3 (distance from the left end and distance from the upper end), the color of the virtual keyboard and the like can be included.

The attribute of each key on the virtual keyboard is controlled using a virtual key table existing on a memory incorporated in the main process unit 11.

The virtual key table is composed of the following items:
kbn; keyboard number corresponding to the key (the same as kbn of the virtual keyboard table),
kyn; key number, wherein each key is discriminated uniquely by kbn and kyn,
Kcode; key code,
Nkb; keyboard number which is to be displayed next (not changed when 0),
Cky; character displayed on the surface (key top) of the display key,
Eky; explanation on the key which is displayed when the key is temporarily selected in a minimum display mode,
Mky; content of the voice message which is outputted when the key is temporarily selected in a voice mode,
Xok; x coordinate of the center of the operation key,
Yok; y coordinate of the center of the operation key,
Wok; width of the operation key,
Hok; height of the operation key,
Xvk; x coordinate of the center of the display key,
Yvk; y coordinate of the center of the display key,
Wvk; width of the display key,
Hvk; height of the display key,
Cns; color of the key which is not selected, and
Cts; color of the key which is temporarily selected.

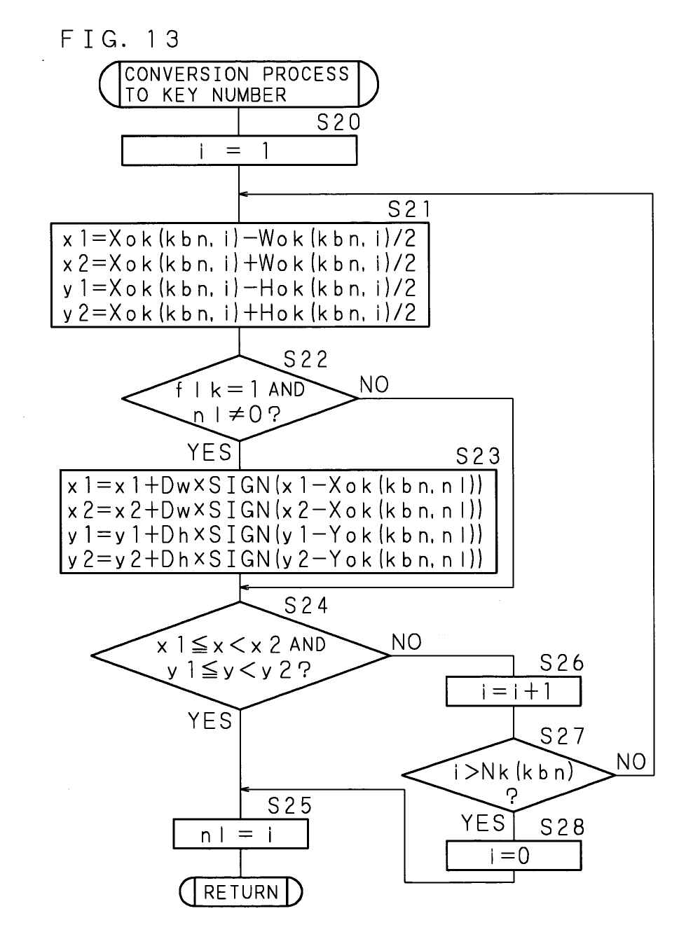

In the process of conversion into the key number (S4), the input signal process unit 10 first sets the parameter i indicating the number of the key area to 1 (FIG. 13: S20).

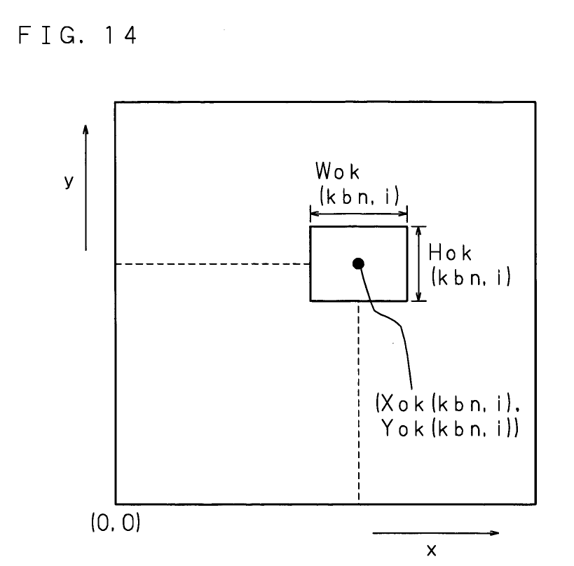

Assuming that the coordinates of the bottom-left corner of the touch pad 5 is (0, 0) as shown in FIG. 14, the input signal process unit 10 then assumes that the center of the area corresponding to the i-th key of the virtual keyboard of the keyboard number kbn is (Xok(kbn, i), Yok(kbn, i)), the width is Wok(kbn, i) and the height is Hok(kbn, i), and calculates: the x coordinate of the left end of the area x1=Xok(kbn, i)−Wok(kbn, i)/2; the x coordinate of the right end of the area x2=Xok(kbn, i)+Wok(kbn, i)/2; the y coordinate of the lower end of the area y1=Yok(kbn, i)−Hok(kbn, i)/2; and the y coordinate of the upper end of the area y2=Yok(kbn, i)+Hok(kbn, i)/2 (S21).

The input signal process unit 10 then judges whether the parameter flk is 1 and the parameter nl to which a key number acquired in the previous judgment (conversion process) is to be entered is 0 or not (S22). When the parameter flk is 1 and the parameter nl is not 0, i.e., when the touch pad 5 was also pushed at the previous time and the position thereof was within the area of the virtual keyboard, the i-th key area is changed (S23).

For changing the area (S23), the input signal process unit 10 calculates:
x1=x1+Dw×SIGN(x1−Xok(kbn, nl));
x2=x2+Dw×SIGN(x2−Xok(kbn, nl));
y1=y1+Dh×SIGN(y1−Yok(kbn, nl)); and
y2=y2+Dh×SIGN(y2−Yok(kbn, nl)).

It should be noted that SIGN(x1−Xok(kbn, nl)) is a function which becomes −1, 0 or 1 respectively when the sign of the calculation result of x1−Xok(kbn, nl) is −, 0 or +.

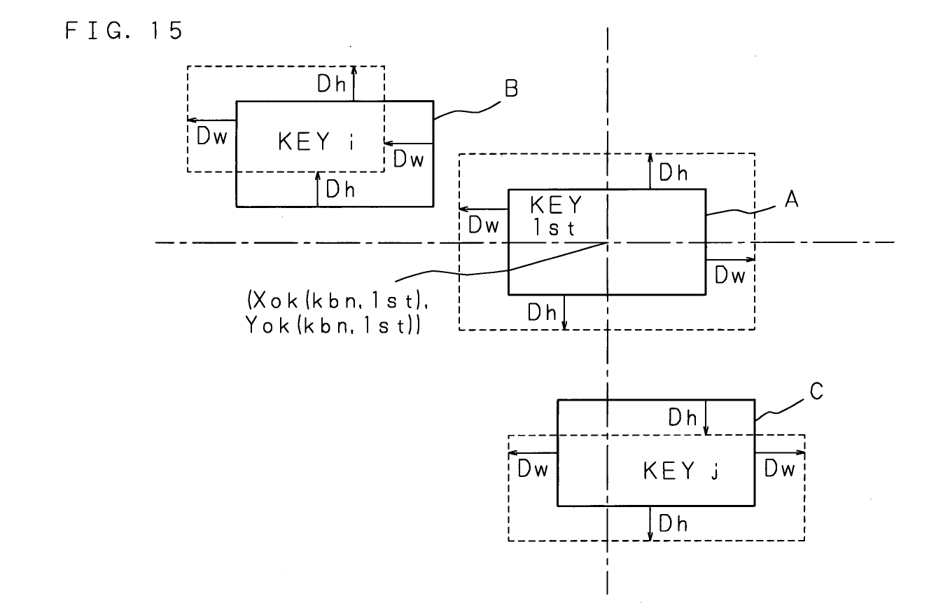

Here, when the touch pad 5 is touched and the touched position is in the vicinity of the boundary between adjoining key areas, the selected key is possibly changed due to a slight change in the position. In order to prevent such chattering, as shown in FIG. 15, when a key was selected at the previous time (the 1st key in FIG. 15), the key is determined at the next time while the key area A is expanded by Dw in the lateral direction and Dh in the vertical direction.

With the expansion, the rest of the key area is also changed. The rule thereof is such that the right end (or left end) of a key area B is shifted to the left by Dw when the right end (or left end) of the key area is on the left side of the center of the 1st key, for example. On the other hand, the right end (or left end) of a key area B is shifted to the right by Dw when the right end (or left end) of the key area is on the right side. The upper end (or lower end) of a key area C is shifted upwards by Dh when the upper end (or lower end) of the key area is on the upper side of the center of the 1st key. On the other hand, the upper end (or lower end) of a key area C is shifted downwards by Dh when the upper end (or lower end) of the key area is on the lower side.

After changing the area (S23), the input signal process unit 10 judges whether x of the acquired (FIG. 12: S3) coordinates (x, y) is within x1 to x2 and y is within y1 to y2 or not (S24), and when x is within x1 to x2 and y is within y1 to y2, the input signal process unit 10 sets the parameter nl to i (S25) and returns the procedure.

When the parameter flk is not 1, or when the parameter nl is 0 (S22), the input signal process unit 10 judges whether x is within x1 to x2 and y is within y1 to y2 or not (S24) without changing the area (S23).

When x is not within x1 to x2, or when y is not within y1 to y2 (S24), the input signal process unit 10 adds 1 to the parameter i (S26) and then judges which of the number of the key area on the virtual keyboard Nk(kbn) and the parameter i is larger (S27). When the parameter i is larger than Nk(kbn), discrimination of key areas the number of which is Nk(kbn) ends, the parameter i is set to 0 (S28) and the parameter nl is set to i (S25). Here, the parameter nl becomes 0 and the key number is not entered.

When the parameter i is not larger than Nk(kbn) (S27), the input signal process unit 10 calculates the range of the area corresponding to the i-th key (S21).

When the finger coming off the touch pad 5 moves slightly on the touch pad surface, there is a possibility that a key number, which the user does not intend to input, is inputted. Consequently, a key buffer kb( ) of an arbitrary size Sb is prepared as shown in FIG. 17 and the key numbers temporarily inputted in a sampling cycle are stored therein in chronological order.

When the finger comes off the touch pad 5, the key numbers in the key buffer kb( ) are examined in reverse chronological order, and a key number is employed as a determinate input key number only when the same key numbers, the number of which is over a predetermined number Nr, are stored continuously. Accordingly, it is possible to prevent input of a key number which the user does not intend to input.

In FIG. 17, seven key numbers have been stored before the finger comes off. Assume that Nr=3 is set. The key numbers are examined starting from kb(7) and the number of times (number) the same key numbers have continued is counted. Here, the same key number 21 has been stored continuously three times from kb(4) to kb(2). Since Nr is not fewer than 3, the key number 21 becomes a determinate input key number.

When Nr=4 is set, any key number does not satisfy the condition. In such a case, the latest key number 17 is employed as a determinate input key number.

In a process of judging a determinate input number (FIG. 12: S9), the input signal process unit 10 first sets the parameter i to the number nk of the key numbers which are stored in the key buffer kb( ) in chronological order (FIG. 16: S30).

The input signal process unit 10 then resets a parameter c indicating the number of the same numbers which are continuously stored in the key buffer kb( ) to 0 (S31).

The input signal process unit 10 then subtracts 1 from the parameter i (S32) and then judges whether the parameter i is 0 or not (S33). When the parameter i is not 0, the input signal process unit 10 judges whether the key number of the kb(i) among the key buffer kb( ) is the same as the key number of the kb(i−1) or not (S34).

When the key number of kb(i) is the same as the key number of kb(i−1) (S34), the input signal process unit 10 adds 1 to the parameter c (S35) and then judges whether the parameter c is equal to the predetermined number Nr or not (S36). When the parameter c is equal to the predetermined number Nr, the input signal process unit 10 determines the key number of kb(i) as the determinate input key number (S37) and returns the procedure.

When the parameter c is not equal to the predetermined number Nr (S36), the input signal process unit 10 subtracts 1 from the parameter i (S32).

When the key number of kb(i) is not equal to the key number of kb(i−1) (S34), the input signal process unit 10 resets the parameter c to 0 (S31).

The parameter i is 0 (S33) means there are not key numbers which are stored continuously over Nr times, the input signal process unit 10 determines the key number of the latest kb(nk) as a determinate input key number (S38) and returns the procedure.

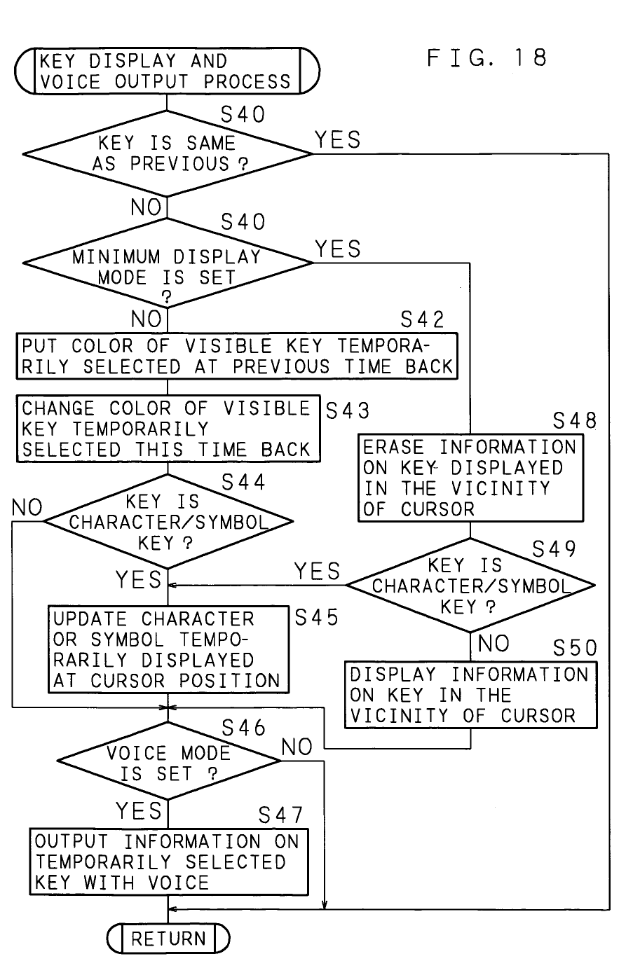

For displaying a key and outputting voice (FIG. 12: S5, S10), the main process unit 11 first judges whether the key is the same as the previous key or not (FIG. 18: S40), and when the key is the same, the main process unit 11 returns the procedure directly. When the key is not the same as the previous key, the main process unit 11 judges whether a minimum display mode is set or not (S41), and when the minimum display mode is not set, the main process unit 11 puts the color of the visible key (key displayed on the display panel 3) which was temporarily selected at the previous time back (S42) and changes the color of the visible key which is temporarily selected this time (S43).

The main process unit 11 then judges whether the key is one of a character key and a symbol key or not (S44), and when the key is one of a character key and a symbol key, the main process unit 11 updates the character or the symbol which has been temporarily displayed at the cursor position (S45).

The main process unit 11 then judges whether the voice mode is set or not (S46), and when the voice mode is set, the main process unit 11 outputs information on the temporarily selected key with voice by the voice process unit 15 and the earphone jack 19 (S47). When the voice mode is not set, the main process unit 11 returns the procedure directly.

The main process unit 11 then judges whether the key is one of a character key and a symbol key or not (S44), and when the key is one of a character key and a symbol key, the main process unit 11 updates the character or the symbol which has been temporarily displayed at the cursor position (S45).

When the key is none of a character key and a symbol key (S44), the main process unit 11 judges whether the voice mode is set or not (S46).

When the minimum display mode is not set (S41), the main process unit 11 erases information on the key which was displayed in the vicinity of the cursor at the previous time (S48), and judges whether the key this time is one of a character key and a symbol key or not (S49).

When the key this time is one of a character key and a symbol key (S49), the main process unit 11 updates the character or the symbol which has been temporarily displayed at the cursor position (S45). When the key this time is none of a character key and a symbol key, the main process unit 11 displays information on the key in the vicinity of the cursor (S50).

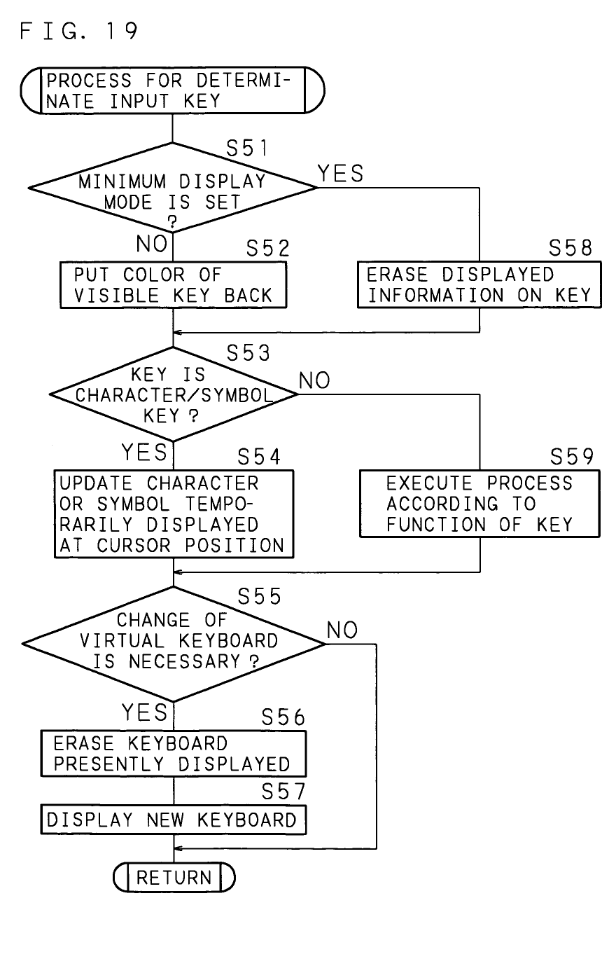

For performing a process on a determinately inputted key (FIG. 12: S11), the main process unit 11 first judges whether the minimum display mode is set or not (FIG. 19: S51), and when the minimum display mode is not set, the main process unit 11 puts the color of the visible key (key displayed on the display panel 3) back (S52). The main process unit 11 then judges whether the key is one of a character key and a symbol key or not (S53).

When the key is one of a character key and a symbol key (S53), the main process unit 11 updates the character or the symbol which has been temporarily displayed at the cursor position (S54), and judges whether a change of the virtual keyboard is necessary or not (S55).

When a change of the virtual keyboard is necessary (S55), the main process unit 11 erases the virtual keyboard presently displayed (S56), displays a new virtual keyboard to be displayed (S57) and returns the procedure. When a change of the virtual keyboard is unnecessary, the main process unit 11 returns the procedure directly.

When the minimum display mode is set (S51) and information on the key is displayed on the display panel 3, the main process unit 11 erases the same (S58) and then judges whether the key is one of a character key and a symbol key or not (S53).

When the key is none of a character key and a symbol key (S53), the main process unit 11 performs a process according to the function of the key (S59) and then judges whether a change of the virtual keyboard is necessary or not (S55).

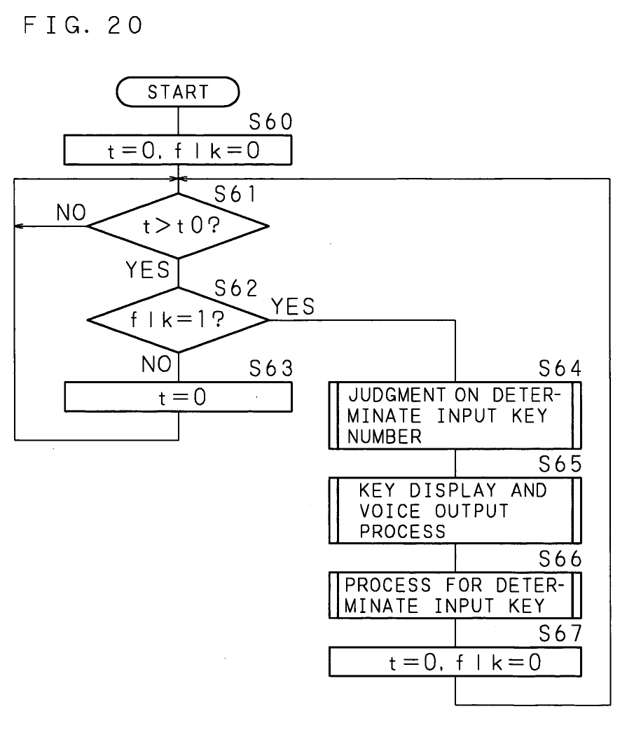

It should be noted that, though the aforementioned flow chart of FIG. 12 shows an example in which whether the touch pad is pushed or not is judged periodically, it is also possible to make an interrupt when the touch pad is pushed. In this case, the input signal process unit 10 first resets a time t clocked by a timer to 0 and resets the parameter flk to 0 (FIG. 20: S60). The parameter flk becomes 1 when the touch pad has been already touched, or 0 when the touch pad has not been touched.

The input signal process unit 10 then judges whether the clocked time t has reached a predetermined time t0 or not (S61), and when the clocked time t has reached the predetermined time t0, the input signal process unit 10 judges whether the parameter flk is 1 or not (S62). When the clocked time t has not reached the predetermined time t0, the input signal process unit 10 waits until the clocked time t reaches the predetermined time t0.

When the parameter flk is not 1 (S62), the input signal process unit 10 resets the time t clocked by the timer to 0 (S63) and then waits until the clocked time t reaches the predetermined time t0 (S61).

When the parameter flk is 1 (S62), the input signal process unit 10 performs a process of judging the determinate input key number (S64) (the same as FIG. 12: S9).

The main process unit 11 receives the judged determinate input key number (S64), displays a key and outputs voice (S65), and then performs a process on a determinately inputted key (S66) (the same as FIG. 12: S10, S11). Meanwhile, the input signal process unit 10 resets the clocked time t and the parameter flk to 0 respectively (S67) and then waits until the clocked time t reaches the predetermined time t0 (S61).

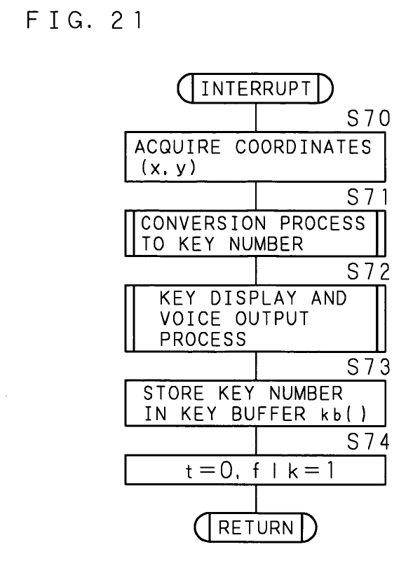

The clocked time t0 is the shortest time for judging that the contact between the touch pad surface and the finger of the user has been broken. That is, it is judged that the finger has come off the touch pad surface when the clocked time t exceeds t0. When a signal is transmitted from the touch pad unit 13 before the clocked time t reaches t0, an interrupt is made, a process shown in the flow chart of FIG. 21 is performed, the clocked time t is set to 0 again, and the parameter flk is set to 1.

The value of the parameter flk is judged at the time when the clocked time t0 has lapsed. The parameter flk becomes 1 when the finger has been touching the touch pad surface until immediately before the predetermined time t0 has lapsed. In this case, it is judged that the contact between the finger and the touch pad surface has been broken and the procedure branches and goes to a routine for judging the determinate input key number. In other cases, no procedure is performed except resetting the clocked time t to zero again and going back.

When an interrupt is made, the input signal process unit 10 acquires the coordinates (x, y) of the pushed position from the touch pad 5 (FIG. 21: S70) and performs a process of converting the coordinates into a key number corresponding to an area including the position (S71) (the same as FIG. 12: S4). The main process unit 11 receives the converted key number, displays a key and outputs voice (S72) (the same as FIG. 12: S5). The input signal process unit 10 makes the key buffer kb( ) shown in FIG. 17 store the converted (S71) key number (S73).

The main process unit 11 receives the coordinates (x, y) and displays a virtual keyboard centering on the coordinates on the display panel 3. Whenever the received coordinates (x, y) are changed, the main process unit 11 moves the virtual keyboard.

The input signal process unit 10 then sets the clocked time t to 0 again, sets the parameter flk to 1 (S74) and returns the procedure.

### Embodiment 2

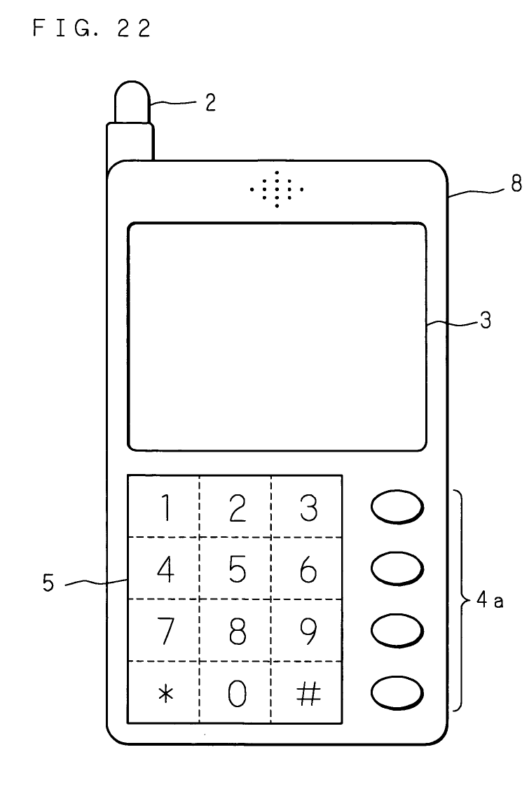

FIG. 22 is a front view showing the appearance of Embodiment 2 of a mobile information device according to the present invention. The mobile information device 8 has a transmit-receive antenna 2 on the upper side of a case, and a display panel 3 which is a display screen configured as a liquid crystal panel is provided at the front upper portion of the case. Provided below the display panel 3 are control buttons 4a and a touch pad 5, which is touched position detecting means of the input device according to the present invention. Since other structures and operations are the same as those of the input device and the mobile telephone according to the present invention which are explained in Embodiment 1, same codes are used to refer to like parts and the explanation thereof is omitted.

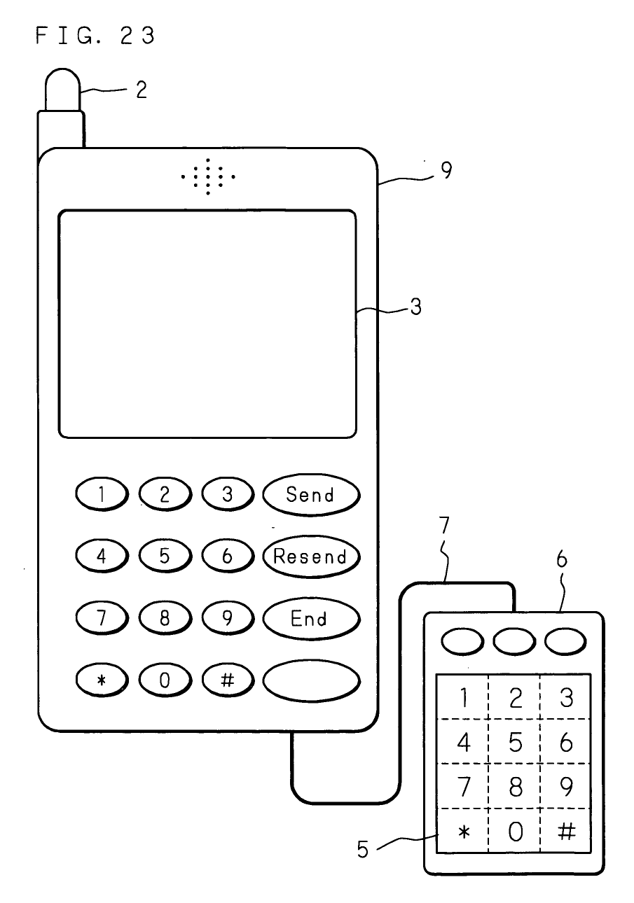

It should be noted that the input device according to the present invention can be realized as an independent general-purpose input device 6 which is to be used as an external device, as shown in FIG. 23, which is connected through a connecting code 7 to a mobile telephone or a mobile information device 9 in which a conventional input device is incorporated.

In this case, required are: not displaying a virtual keyboard on the display panel 3 of the mobile information device 9 or the mobile telephone; and not transmitting key codes of a special key and a control key to the mobile information device 9 or the mobile telephone when those keys are temporarily inputted, i.e., executing the function of the key only at the time of determinate input.

The input device according to the present invention can also be realized as an independent dedicated input device 6 which is to be used as an external device connected through a connecting code 7 to the mobile information device 9 or a mobile telephone. In this case, the aforementioned constraint is not required since the software can linked up with the mobile information device 9 or the mobile telephone.

It should be noted, though each of the aforementioned embodiments explains an example in which a touch pad is used as touched position detecting means, a touch panel can be used instead of the touch pad.

Availability on Industry

With an input device according to the first invention, generating of an input mistake can be decreased since a character is determined after checking an inputted character, any one of kana characters, alphabet characters and the like can be selected and inputted by a single operation, and an irrefrangible input device can be realized. Moreover, the user can increase the input speed as he gets more familiar with the key positions on the virtual keyboard, keys can be arranged on space-saving touched position detecting means in an extremely high density, and many functions can be added by using the input device also as a pointing device, a hand written character input device, a free line input device or the like.

With an input device according to the second invention, keys can be arranged on space-saving touched position detecting means in an extremely high density, generating of an input mistake can be decreased since a group of characters or a group of symbols can be determined after checking a group of inputted characters or symbols, any one of groups of kana characters, groups of alphabet characters and the like can be selected and inputted by a single operation, and an irrefrangible input device can be realized.

With an input device according to the third invention, generating of an input mistake can be decreased even in a space-saving device, keys can be arranged on space-saving touched position detecting means in an extremely high density, any one of kana characters, alphabet characters and the like can be selected and inputted by a single operation, and an irrefrangible input device can be realized.

With an input device according to the fourth invention, generating of an input mistake can be decreased by preventing chattering at the time of input, keys can be arranged on space-saving touched position detecting means in an extremely high density, any one of kana characters, alphabet characters and the like can be selected and inputted by a single operation, and an irrefrangible input device can be realized.

With an input device according to the fifth invention, an input is easy even for a beginner, keys can be arranged on space-saving touched position detecting means in an extremely high density, any one of kana characters, alphabet characters and the like can be selected and inputted by a single operation, and an irrefrangible input device can be realized.

With an input device according to the sixth invention, a function key is provided, keys can be arranged on space-saving touched position detecting means in an extremely high density, any one of kana characters, alphabet characters and the like can be selected and inputted by a single operation, and an irrefrangible input device can be realized.

With an input device according to the seventh invention, the user can select a virtual keyboard with which an input is easy for him, keys can be arranged on space-saving touched position detecting means in an extremely high density, any one of kana characters, alphabet characters and the like can be selected and inputted by a single operation, and an irrefrangible input device can be realized.

With an input device according to the eighth invention, it is easy to dial, keys can be arranged on space-saving touched position detecting means in an extremely high density, any one of kana characters, alphabet characters and the like can be selected and inputted by a single operation, and an irrefrangible input device can be realized.

With an input device according to the ninth invention or the tenth invention, an input is easy, generating of an input mistake can be decreased, keys can be arranged on space-saving touched position detecting means in an extremely high density, any one of kana characters, alphabet characters and the like can be selected and inputted by a single operation, and an irrefrangible input device can be realized.

With an input device according to the eleventh invention, an input is easy, generating of an input mistake can be decreased, keys can be arranged on space-saving touched position detecting means in an extremely high density, any one of kana characters, alphabet characters and the like can be selected and inputted faster by two operations, and an irrefrangible input device can be realized.

With an input device according to the twelfth invention, an input is easy even for a visually impaired person, generating of an input mistake can be decreased, keys can be arranged on space-saving touched position detecting means in an extremely high density, keys to be arranged can be reduced, any one of kana characters, alphabet characters and the like can be selected and inputted by a simple operation, and an irrefrangible input device can be realized.

With an input device according to the thirteenth invention, an input is easy, generating of an input mistake can be decreased, keys can be arranged on space-saving touched position detecting means in an extremely high density, any one of kana characters, alphabet characters and the like can be selected and inputted by a simple operation, and an irrefrangible input device can be realized.

With a mobile telephone according to the fourteenth invention, generating of an input mistake can be decreased, keys can be arranged on space-saving touched position detecting means in an extremely high density, any one of kana characters, alphabet characters and the like can be selected and inputted by a simple operation, and a mobile telephone with an irrefrangible input device can be realized.

With a mobile information device according to the fifteenth invention, generating of an input mistake can be decreased, keys can be arranged on space-saving touched position detecting means in an extremely high density, any one of kana characters, alphabet characters and the like can be selected and inputted by a simple operation, and a mobile information device with an irrefrangible input device can be realized.

1-15. (canceled)

16. An input device which has touched position detecting means for outputting a signal indicating a touched position thereof during a period of time of touch, and is configured so as to input a character and a symbol to be displayed on a display screen, comprising:
a virtual keyboard in which each virtual key corresponding to a plurality of characters or symbols is arranged corresponding to each divided area on said touched position detecting means;
means for outputting, during the period of time of touch, a code signal indicating a character or a symbol of a virtual key corresponding to an area including said touched position;
means for temporarily displaying on said display screen a character or a symbol of the code signal outputted by said means; and
means for determinately displaying the character or the symbol on said display screen when the code signal has disappeared.

17. The input device according to claim 16, further comprising means for expanding an area including said touched position during the period of time of touch.

18. The input device according to claim 16, wherein said means for determinately displaying provides a determinate display when said code signal has continued, in a first time period immediately before said code signal has disappeared, for more than a second time period which is shorter than said first time period.

19. The input device according to claim 16, further comprising means for displaying on said display screen a portion centering on an area including said touched position of said virtual keyboard or a whole area of the virtual keyboard.

20. The input device according to claim 16, wherein
said virtual keyboard includes one or a plurality of virtual keys respectively indicating a predetermined function, and
said input device further comprises: means for outputting a signal indicating said function when an area of said virtual key includes said touched position; and means for executing said function indicated by the signal outputted by said means.

21. The input device according to claim 16, further comprising:
a plurality of kinds of said virtual keyboards; and
switching means for switching and displaying one of said virtual keyboards on said display screen.

22. The input device according to claim 21, wherein
said plurality of kinds of virtual keyboards includes a ten-key keypad,
a number or a symbol of a ten-key keypad corresponding to each said area is printed on said touched position detecting means, and
the virtual keyboard is not displayed on said screen when said switching means switches the virtual keyboard to the ten-key keypad.

23. The input device according to claim 16, wherein projections for each said area are provided on said touched position detecting means.

24. The input device according to claim 23, wherein a groove is provided on a boundary of each said area on said touched position detecting means.

25. The input device according to claim 16, wherein characters and symbols are divided into a plurality of sets based on a predetermined condition and each virtual key respectively corresponds to a character or a symbol respectively indicating a set, wherein when a character or a symbol indicating a set is selected, each virtual key corresponds to a character or a symbol of the set indicated by the selected character or symbol.

26. The input device according to claim 16, further comprising:
means for selectively displaying, instead of a virtual keyboard, a virtual key or information related to content displayed on said display screen; and
means for switching between a state where said means operates and a state where said means does not operate.

27. The input device according to claim 16, further comprising means for outputting voice corresponding to the content displayed on said display screen.

28. An input device which has touched position detecting means for outputting a signal indicating a touched position thereof during a period of time of touch, and is configured so as to input a group of characters and a group of symbols to be displayed on a display screen, comprising:
a virtual keyboard in which each virtual key corresponding to a plurality of groups of characters or groups of symbols is arranged corresponding to each divided area on said touched position detecting means;
means for outputting, during the period of time of touch, a code signal indicating a group of characters or a group of symbols of a virtual key corresponding to an area including said touched position;
means for temporarily displaying on said display screen a group of characters or a group of symbols of the code signal outputted by said means; and
means for determinately displaying the group of characters or the group of symbols on said display screen when said code signal has disappeared.

29. The input device according to claim 28, further comprising means for expanding an area including said touched position during the period of time of touch.

30. The input device according to claim 28, wherein said means for determinately displaying provides a determinate display when said code signal has continued, in a first time period immediately before said code signal has disappeared, for more than a second time period which is shorter than said first time period.

31. The input device according to claim 28, further comprising means for displaying on said display screen a portion centering on an area including said touched position of said virtual keyboard or a whole area of the virtual keyboard.

32. The input device according to claim 28, wherein
said virtual keyboard includes one or a plurality of virtual keys respectively indicating a predetermined function, and
said input device further comprises: means for outputting a signal indicating said function when an area of said virtual key includes said touched position; and means for executing said function indicated by the signal outputted by said means.

33. The input device according to claim 28, further comprising:
a plurality of kinds of said virtual keyboards; and
switching means for switching and displaying one of said virtual keyboards on said display screen.

34. The input device according to claim 33, wherein
said plurality of kinds of virtual keyboards includes a ten-key keypad,
a number or a symbol of a ten-key keypad corresponding to each said area is printed on said touched position detecting means, and
the virtual keyboard is not displayed on said screen when said switching means switches the virtual keyboard to the ten-key keypad.

35. The input device according to claim 28, wherein projections for each said area are provided on said touched position detecting means.

36. The input device according to claim 35, wherein a groove is provided on a boundary of each said area on said touched position detecting means.

37. The input device according to claim 28, wherein characters and symbols are divided into a plurality of sets based on a predetermined condition and each virtual key respectively corresponds to a character or a symbol respectively indicating a set, wherein when a character or a symbol indicating a set is selected, each virtual key corresponds to a character or a symbol of the set indicated by the selected character or symbol.

38. The input device according to claim 28, further comprising:
means for selectively displaying, instead of a virtual keyboard, a virtual key or information related to content displayed on said display screen; and
means for switching between a state where said means operates and a state where said means does not operate.

39. The input device according to claim 28, further comprising means for outputting voice corresponding to the content displayed on said display screen.

40. A mobile telephone which has an input device for inputting a character and a symbol, and displays a character or a symbol inputted through said input device on said display screen and executes a function inputted and instructed through said input device, wherein said input device comprises:
touched position detecting means for outputting a signal indicating a touched position thereof during a period of time of touch;
a virtual keyboard in which each virtual key corresponding to a plurality of characters or symbols is arranged corresponding to each divided area on said touched position detecting means;
means for outputting, during the period of time of touch, a code signal indicating a character or a symbol of a virtual key corresponding to an area including said touched position;
means for temporarily displaying on said display screen a character or a symbol of the code signal outputted by said means; and
means for determinately displaying the character or the symbol on said display screen when the code signal has disappeared.

41. The mobile telephone according to claim 50, wherein
said virtual keyboard includes one or a plurality of virtual keys respectively indicating a predetermined function, and
said input device further comprises: means for outputting a signal indicating said function when an area of said virtual key includes said touched position; and means for executing said function indicated by the signal outputted by said means.

42. The mobile telephone according to claim 50, further comprising:
a plurality of kinds of said virtual keyboards; and
switching means for switching and displaying one of said virtual keyboards on said display screen.

43. The mobile telephone according to claim 52, wherein
said plurality of kinds of virtual keyboards includes a ten-key keypad,
a number or a symbol of a ten-key keypad corresponding to each said area is printed on said touched position detecting means, and
the virtual keyboard is not displayed on said screen when said switching means switches the virtual keyboard to the ten-key keypad.

44. A mobile telephone which has an input device for inputting a group of characters and a group of symbols, and displays a group of characters or a group of symbols inputted through said input device on said display screen and executes a function inputted and instructed through said input device, wherein said input device comprises:
touched position detecting means for outputting a signal indicating a touched position thereof during a period of time of touch;
a virtual keyboard in which each virtual key corresponding to a plurality of groups of characters or groups of symbols is arranged corresponding to each divided area on said touched position detecting means;
means for outputting, during the period of time of touch, a code signal indicating a group of characters or a group of symbols of a virtual key corresponding to an area including said touched position;
means for temporarily displaying on said display screen a group of characters or a group of symbols the code signal outputted by said means; and
means for determinately displaying the group of characters or the group of symbols on said display screen when the code signal has disappeared.

45. The mobile telephone according to claim 44, wherein
said virtual keyboard includes one or a plurality of virtual keys respectively indicating a predetermined function, and
said input device further comprises: means for outputting a signal indicating said function when an area of said virtual key includes said touched position; and means for executing said function indicated by the signal outputted by said means.

46. The mobile telephone according to claim 44, further comprising:
a plurality of kinds of said virtual keyboards; and
switching means for switching and displaying one of said virtual keyboards on said display screen.

47. The mobile telephone according to claim 46, wherein
said plurality of kinds of virtual keyboards includes a ten-key keypad,
a number or a symbol of a ten-key keypad corresponding to each said area is printed on said touched position detecting means, and
the virtual keyboard is not displayed on said screen when said switching means switches the virtual keyboard to the ten-key keypad.

48. A mobile information device which has an input device for inputting a character and a symbol, and displays a character or a symbol inputted through said input device on said display screen and executes a function inputted and instructed through said input device, wherein said input device comprises:
touched position detecting means for outputting a signal indicating a touched position thereof during a period of time of touch;
a virtual keyboard in which each virtual key corresponding to a plurality of characters or symbols is arranged corresponding to each divided area on said touched position detecting means;
means for outputting, during the period of time of touch, a code signal indicating a character or a symbol of a virtual key corresponding to an area including said touched position;
means for temporarily displaying on said display screen a character or a symbol of the code signal outputted by said means; and
means for determinately displaying the character or the symbol on said display screen when the code signal has disappeared.

49. The mobile information device according to claim 48, wherein
said virtual keyboard includes one or a plurality of virtual keys respectively indicating a predetermined function, and
said input device further comprises: means for outputting a signal indicating said function when an area of said virtual key includes said touched position; and means for executing said function indicated by the signal outputted by said means.

50. The mobile information device according to claim 48, further comprising:
a plurality of kinds of said virtual keyboards; and
switching means for switching and displaying one of said virtual keyboards on said display screen.

51. The mobile information device according to claim 50, wherein
said plurality of kinds of virtual keyboards includes a ten-key keypad,
a number or a symbol of a ten-key keypad corresponding to each said area is printed on said touched position detecting means, and
the virtual keyboard is not displayed on said screen when said switching means switches the virtual keyboard to the ten-key keypad.

52. A mobile information device which has an input device for inputting a group of characters and a group of symbols, and displays a group of characters or a group of symbols inputted through said input device on said display screen and executes a function inputted and instructed through said input device, wherein said input device comprises:
touched position detecting means for outputting a signal indicating a touched position thereof during a period of time of touch;
a virtual keyboard in which each virtual key corresponding to a plurality of groups of characters or groups of symbols is arranged corresponding to each divided area on said touched position detecting means;
means for outputting, during the period of time of touch, a code signal indicating a group of characters or a group of symbols of a virtual key corresponding to an area including said touched position;
means for temporarily displaying on said display screen a group of characters or a group of symbols the code signal outputted by said means; and
means for determinately displaying the group of characters or the group of symbols on said display screen when the code signal has disappeared.

53. The mobile information device according to claim 52, wherein
said virtual keyboard includes one or a plurality of virtual keys respectively indicating a predetermined function, and
said input device further comprises: means for outputting a signal indicating said function when an area of said virtual key includes said touched position; and means for executing said function indicated by the signal outputted by said means.

54. The mobile information device according to claim 52, further comprising:
a plurality of kinds of said virtual keyboards; and
switching means for switching and displaying one of said virtual keyboards on said display screen.

55. The mobile information device according to claim 54, wherein
said plurality of kinds of virtual keyboards includes a ten-key keypad,
a number or a symbol of a ten-key keypad corresponding to each said area is printed on said touched position detecting means, and
the virtual keyboard is not displayed on said screen when said switching means switches the virtual keyboard to the ten-key keypad.
